(19) United States
(12) Patent Application Publication
(10) Pub. No.: US 2026/0350347 A1
(43) Pub. Date: Nov. 5, 2026

(54) SCALE-INVARIANT INVERSE-SQUARE KERNEL FOR GRAPH NEURAL-NETWORK MESSAGE PASSING

(71) Applicant: Jonathan Washburn, Austin, TX (US)

(72) Inventor: Jonathan Washburn, Austin, TX (US)

(21) Appl. No.: 19/663,077

(22) Filed: Apr. 29, 2026

Related U.S. Application Data
(60) Provisional application No. 63/797,344, filed on Apr. 30, 2025.

(51) Int. Cl. G06N 3/042

(52) U.S. Cl. CPC G06N 3/042

(57) ABSTRACT

A graph neural-network message-passing technique computes edge weights using a deterministic scale-normalized inverse-square kernel. For edges between nodes having associated coordinates, a deterministic graph scale is computed from graph geometry, and edge weights are computed as a function of pairwise node-coordinate distance and a damping term coupled to the deterministic graph scale. In disclosed embodiments, the edge weight is computed according to w_ij=s_G\hat{ }2/(∥x_i−x_j∥\hat{ }2+(epsilon s_G)\hat{ }2), or equivalently w_ij=1/(((∥x_i−x_j∥)/s_G)\hat{ }2+epsilon\hat{ }2), where epsilon is fixed at X_opt=phi/pi and the exponent on distance is fixed at −2. Because the deterministic graph scale varies proportionally under uniform graph dilation, the edge weights are exactly invariant under graph dilation.

### CROSS-REFERENCE TO RELATED APPLICATIONS

This application claims the benefit of priority to U.S. Provisional Patent Application No. 63/797,344, filed Apr. 30, 2025, the entirety of which is hereby incorporated by reference herein.

### BACKGROUND

The present disclosure relates generally to geometric deep learning and, more particularly, to graph neural-network message-passing architectures that use coordinate-dependent edge weights. More specifically, the present disclosure relates to an analytic, parameter-free inverse-square kernel for graph neural-network message passing, together with software, processor-implemented, and system embodiments configured to compute and apply such kernel. Graph neural networks generally update node representations by aggregating messages received from neighboring nodes. In a message-passing layer, the update of a destination node depends on an edge-weighting kernel w_ij that determines the relative contribution of information received from a source node j to a destination node i. Existing graph neural-network approaches use edge-weighting or aggregation schemes based on, for example, degree-normalized weights, learned attention weights, uniform aggregation weights, Gaussian kernels, Bessel kernels, or other learned or tuneable edge functions. While such approaches may be useful in selected settings, they do not provide exact scale invariance under graph dilation.

The present disclosure addresses that problem with a specific kernel rule in which edge weights are computed as a deterministic scale-normalized inverse-square function of node-coordinate distance:

w_ij=s_G\hat{ }2/(∥x_i−x_j∥\hat{ }2+(epsilon s_G)\hat{ }2)

or equivalently:

w_ij=1/(((∥x_i−x_j∥)/s_G)\hat{ }2+epsilon\hat{ }2)

where s_G is a deterministic graph scale, epsilon is fixed at X_opt=phi/pi, and the exponent on distance is fixed at −2. Because s_G scales linearly under graph dilation, the disclosed kernel is exactly invariant under uniform scaling of graph coordinates. The disclosed inverse-square form is not presented as an interchangeable power-law family. In the present disclosure, the exponent is fixed at −2, the damping constant is fixed at X_opt=phi/pi, and the graph scale is deterministic. A bare 1/r\hat{ }2 kernel diverges at r=0; the disclosed invention regularizes that singularity through the fixed damping term epsilon s_G while preserving inverse-square behavior away from zero. The problem addressed, accordingly, is how to define and use a deterministic, analytic, parameter-free, exactly scale-invariant inverse-square kernel for graph neural-network message passing.

### SUMMARY

The present disclosure provides an analytic, parameter-free inverse-square kernel for graph neural-network message passing. In the disclosed invention, edge weights are computed as a deterministic scale-normalized function of node-coordinate distance:

w_ij=s_G\hat{ }2/(∥x_i−x_j∥\hat{ }2+(epsilon s_G)\hat{ }2)

or equivalently:

w_ij=1/(((∥x_i−x_j∥)/s_G)\hat{ }2+epsilon\hat{ }2)

where s_G is a deterministic graph scale, epsilon is fixed at X_opt=phi/pi, and the exponent on distance is fixed at −2. By construction, the edge weights are exactly invariant under uniform graph dilation. The disclosed kernel uses no learned attention weights and no learned edge-weight hyperparameters.

In certain implementations, messages are formed by weighting transformed neighbor features with the disclosed kernel and aggregating such weighted messages to produce updated node representations. The disclosed kernel may therefore be embodied as a graph neural-network layer, a processor-implemented method, a software module, a system, or a non-transitory computer-readable medium configured to compute a deterministic graph scale, compute inverse-square edge weights, form weighted messages, and aggregate such messages.

Technical support for the disclosed kernel includes an exact derivation of scale invariance under graph dilation, explicit mathematical properties of the kernel, formal verification of selected kernel properties, software implementations demonstrating make-and-use detail, and experimental benchmarks and ablation results validating implemented embodiments.

Additional sparse, software, system, hardware, and application-specific embodiments may also be disclosed. Such embodiments remain subordinate to the kernel rule set out above.

### BRIEF DESCRIPTION OF THE DRAWINGS

FIG. 1 is a schematic diagram of an example graph neural-network system configured to perform deterministic scale-normalized inverse-square message passing.

FIG. 2 is a schematic diagram illustrating exact scale invariance of the disclosed kernel under uniform graph dilation.

FIG. 3 is a flow diagram of an example method for computing deterministic scale-normalized inverse-square edge weights and generating updated node features.

FIG. 4 is a block diagram of an example message-passing layer implementing the disclosed inverse-square kernel.

FIG. 5 is a schematic diagram illustrating example coordinate-source embodiments and graph-construction embodiments.

FIG. 6 is a schematic support diagram distinguishing formal verification support for kernel properties from empirical validation results.

FIG. 7 is a schematic diagram illustrating optional and alternative embodiments of the disclosed kernel.

FIG. 8 is a block diagram of an example processor-implemented system and optional hardware embodiment configured to compute the disclosed kernel.

FIG. 9 is a schematic diagram illustrating example downstream application contexts in which the disclosed kernel may be used.

### DETAILED DESCRIPTION OF THE DRAWINGS

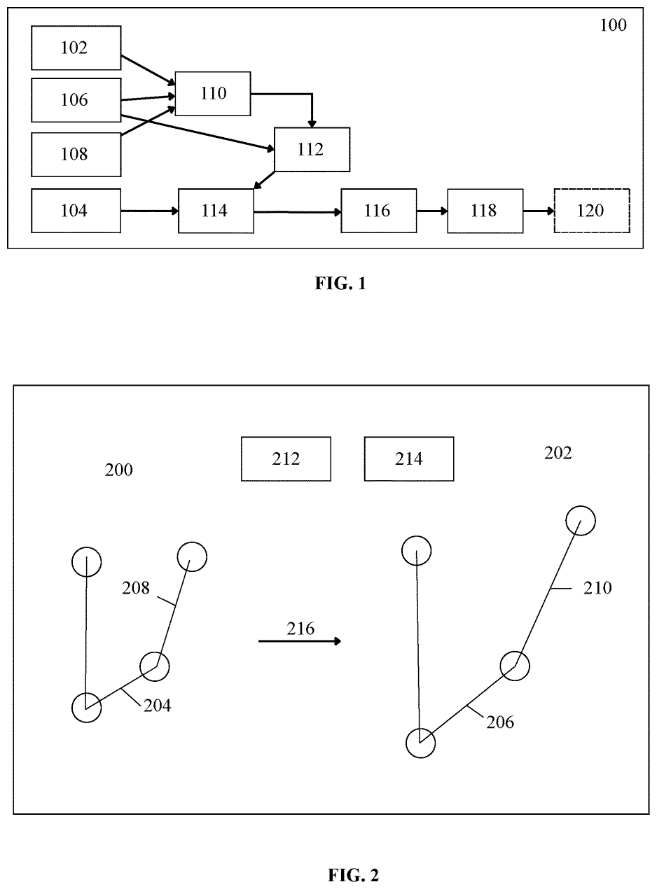

FIG. 1 illustrates an example graph neural-network system 100 configured to perform deterministic scale-normalized inverse-square message passing.

In FIG. 1, numeral 102 denotes a graph input, numeral 104 denotes a node feature input, numeral 106 denotes a node coordinate input, and numeral 108 denotes an edge-set input.

Numeral 110 denotes a deterministic graph-scale module, numeral 112 denotes an inverse-square kernel module, numeral 114 denotes a message-generation module, numeral 116 denotes an aggregation/update module, numeral 118 denotes output node representations, and numeral 120 denotes an optional downstream task head.

FIG. 1 therefore depicts the overall system architecture in which graph structure, features, and coordinates are used to compute the disclosed kernel and produce updated node representations.

FIG. 2 illustrates exact scale invariance of the disclosed kernel under uniform graph dilation.

In FIG. 2, numeral 200 denotes a first graph configuration, numeral 202 denotes a second graph configuration obtained by dilation of the first graph, numeral 204 denotes an edge distance in the first graph configuration, numeral 206 denotes a corresponding scaled edge distance in the second graph configuration, numeral 208 denotes a deterministic graph scale associated with the first graph configuration, numeral 210 denotes a corresponding scaled graph scale associated with the second graph configuration, numeral 212 denotes a normalized distance term, numeral 214 denotes a resulting edge weight, and numeral 216 denotes the dilation transformation.

FIG. 2 therefore depicts that proportional scaling of both coordinate distance and deterministic graph scale leaves the normalized kernel weight unchanged.

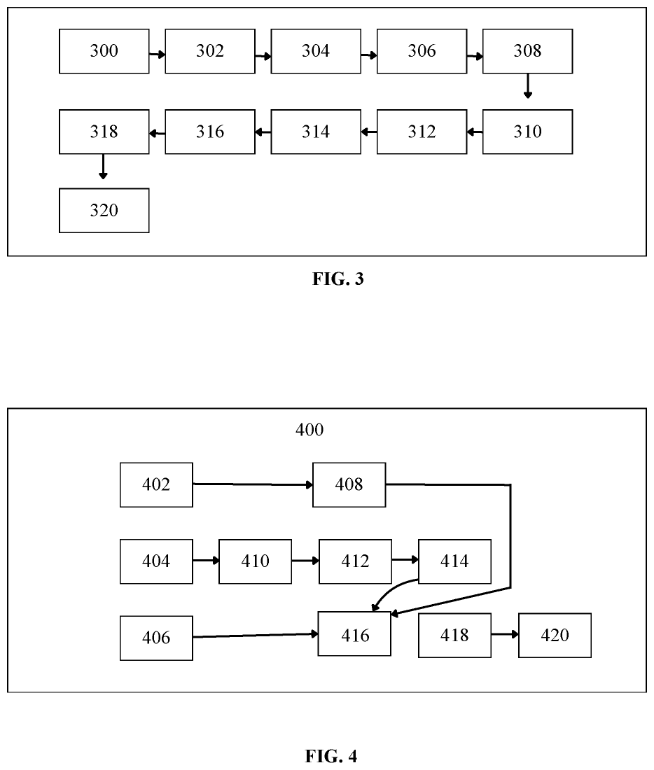

FIG. 3 illustrates an example method flow for computing deterministic scale-normalized inverse-square edge weights and generating updated node features.

In FIG. 3, numeral 300 denotes receipt of graph data, numeral 302 denotes receipt of node features, numeral 304 denotes receipt of node coordinates, numeral 306 denotes determination of an edge set, numeral 308 denotes computation of a deterministic graph scale, numeral 310 denotes computation of edge weights using the disclosed kernel, numeral 312 denotes transformation of source-node features, numeral 314 denotes generation of weighted messages, numeral 316 denotes aggregation of messages, numeral 318 denotes application of an activation or update, and numeral 320 denotes output of updated node or graph features.

FIG. 3 therefore depicts an illustrative operational workflow from graph input through kernel-weighted message passing to updated output representations.

FIG. 4 illustrates an example message-passing layer implementing the disclosed inverse-square kernel.

In FIG. 4, numeral 400 denotes the layer architecture as a whole, numeral 402 denotes layer input features, numeral 404 denotes layer input coordinates, numeral 406 denotes an edge-index input, numeral 408 denotes a feature-transform module, numeral 410 denotes a graph-scale computation module, numeral 412 denotes a normalized-distance module, numeral 414 denotes an inverse-square weight module, numeral 416 denotes a message-formation module, numeral 418 denotes an aggregation module, and numeral 420 denotes an output feature module.

FIG. 4 therefore depicts a layer-level realization of the disclosed kernel within a graph neural-network message-passing architecture.

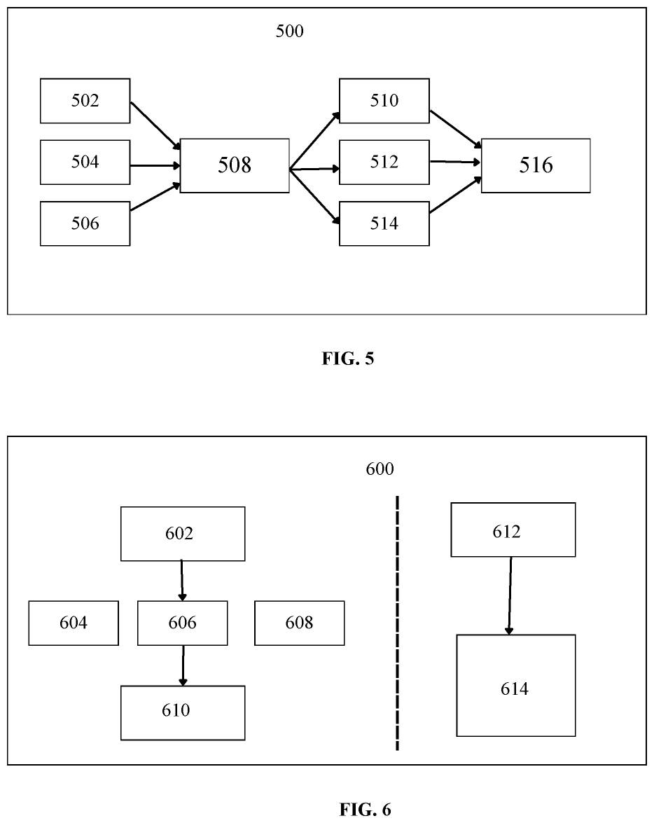

FIG. 5 illustrates example coordinate-source embodiments and graph-construction embodiments.

In FIG. 5, numeral 500 denotes the coordinate-source embodiment diagram as a whole, numeral 502 denotes a spatial-coordinate source, numeral 504 denotes a latent-coordinate generator, numeral 506 denotes a precomputed embedding source, numeral 508 denotes a coordinate-selection module, numeral 510 denotes a native edge-set path, numeral 512 denotes a k-nearest-neighbor edge-construction path, numeral 514 denotes a sparse graph-processing path, and numeral 516 denotes a message-passing graph output.

FIG. 5 therefore depicts different coordinate sources and edge-set construction paths that may be used while preserving the disclosed kernel rule.

FIG. 6 illustrates separation between formal verification support and empirical validation support for the disclosed kernel.

In FIG. 6, numeral 600 denotes a support overview, numeral 602 denotes a benchmark-results panel, numeral 604 denotes a first benchmark panel, numeral 606 denotes a second benchmark panel, numeral 608 denotes a third benchmark panel, numeral 610 denotes a convergence/overhead observation panel, numeral 612 denotes a formal-verification panel, and numeral 614 denotes a proved-property list.

FIG. 6 therefore depicts, in concrete form, that theorem-backed mathematical properties of the kernel are maintained separately from empirical implementation results.

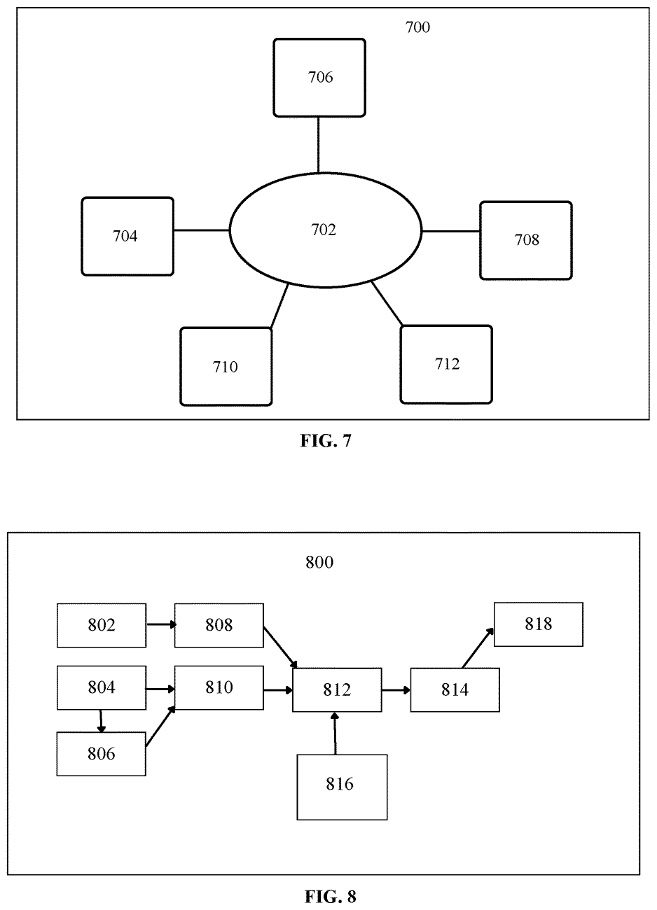

FIG. 7 illustrates optional and alternative embodiments of the disclosed kernel while keeping the base kernel visually central.

In FIG. 7, numeral 700 denotes the optional/alternative embodiment diagram as a whole, numeral 702 denotes a base-kernel embodiment, numeral 704 denotes a directional branch, numeral 706 denotes a multi-head branch, numeral 708 denotes a temporal branch, numeral 710 denotes a hyperbolic branch, and numeral 712 denotes a sparse-neighbor branch.

FIG. 7 therefore depicts optional breadth embodiments that remain subordinate to the disclosed deterministic scale-normalized inverse-square kernel.

FIG. 8 illustrates an example processor-implemented system and optional hardware embodiment configured to compute the disclosed kernel.

In FIG. 8, numeral 800 denotes the processor-implemented system as a whole, numeral 802 denotes a processor, numeral 804 denotes memory, numeral 806 denotes a graph data store, numeral 808 denotes a feature-transform engine, numeral 810 denotes a graph-scale computation engine, numeral 812 denotes an inverse-square kernel engine, numeral 814 denotes an aggregation engine, numeral 816 denotes an optional dedicated arithmetic accelerator, and numeral 818 denotes an output interface.

FIG. 8 therefore depicts an optional system-level and hardware-assisted realization of the disclosed kernel.

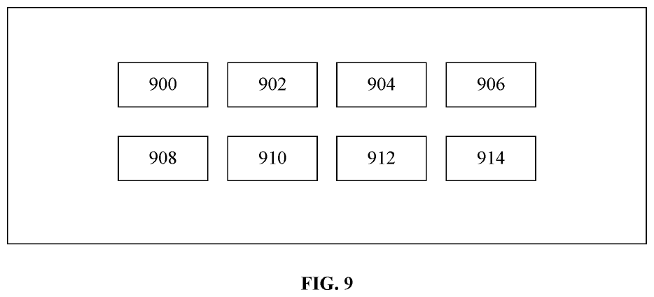

FIG. 9 illustrates example downstream application contexts in which the disclosed kernel may be used.

In FIG. 9, numeral 900 denotes a molecular-graph application, numeral 902 denotes a materials-graph application, numeral 904 denotes a citation-network application, numeral 906 denotes a protein-interaction application, numeral 908 denotes an autonomous-scene-graph application, numeral 910 denotes a social-network application, numeral 912 denotes a point-cloud application, and numeral 914 denotes a multi-resolution transfer application.

FIG. 9 therefore depicts illustrative downstream uses that remain subordinate to the defined kernel rule.

### DETAILED DESCRIPTION

The present disclosure is directed to a deterministic, analytic, parameter-free inverse-square kernel for graph neural-network message passing. The disclosed edge weight is computed from node-coordinate distance using a deterministic graph scale, a fixed damping constant epsilon=X_opt=phi/pi, and a fixed inverse-square dependence with exponent −2, such that the edge weights are exactly invariant under graph dilation. In the disclosed invention, the kernel is defined by the rule:

w_ij=s_G\hat{ }2/(∥x_i−x_j∥\hat{ }2+(epsilon s_G)\hat{ }2)

or equivalently:

w_ij=1/(((∥x_i−x_j∥)/s_G)\hat{ }2+epsilon\hat{ }2)

where s_G is a deterministic graph scale computed from graph geometry. The disclosed kernel is parameter-free in that it uses no learned attention weights and no learned edge-weight hyperparameters.

For purposes of the present disclosure, a graph may include a plurality of nodes and a plurality of edges connecting selected pairs of nodes. Each node may be associated with a feature vector h_i and, in disclosed embodiments, with coordinates x_i. The coordinates may be physical coordinates, learned latent coordinates, or precomputed positional embeddings. The edge set used for message passing may be denoted E. For an edge between nodes i and j, the pairwise coordinate distance may be represented as ∥x_i−x_j∥. A deterministic graph scale s_G is computed from graph geometry and is used to normalize the inverse-square edge-weighting rule.

As shown schematically in FIG. 1, an example graph neural-network system 100 may include a graph input 102, node feature input 104, node coordinate input 106, edge-set input 108, deterministic graph-scale module 110, inverse-square kernel module 112, message-generation module 114, aggregation/update module 116, output node representations 118, and optional downstream task head 120. The optional downstream task head 120 may receive updated node or graph representations for a selected task without altering the disclosed kernel rule.

In a preferred implementation, the deterministic graph scale is computed according to:

s_G\hat{ }2=(1/|E|) sum over (i,j) in E of ∥x_i−x_j∥\hat{ }2

This quantity may be understood as an RMS edge-length scale computed from the edge set E used for message passing. The foregoing expression is the principal taught implementation of the deterministic graph scale in the present disclosure. Using that deterministic graph scale, the disclosed edge weight for an edge between node i and node j is:

w_ij=s_G\hat{ }2/(∥x_i−x_j∥\hat{ }2+(epsilon s_G)\hat{ }2)

which may also be written in normalized form as:

w_ij=1/(((∥x_i−x_j∥)/s_G)\hat{ }2+epsilon\hat{ }2)

where x_i and x_j are node coordinates, E is the edge set used for message passing, s_G is the deterministic graph scale, epsilon=X_opt=phi/pi, and the exponent on distance is fixed at −2. In the disclosed implementation, epsilon=X_opt=phi/pi≈0.515036214800. The disclosed kernel is analytic and closed-form. It is not an attention mechanism. It does not learn edge weights from node-pair features. It does not tune a free edge-kernel exponent. It does not tune a free damping family in the disclosed core form. The disclosed rule is a deterministic, scale-normalized inverse-square kernel with epsilon fixed at X_opt=phi/pi and exponent fixed at −2. A bare 1/r\hat{ }2 kernel diverges at r=0. In the disclosed kernel, that singularity is regularized through the fixed damping term (epsilon s_G)\hat{ }2, with epsilon fixed at X_opt=phi/pi.

Accordingly, the disclosed invention preserves inverse-square behavior away from zero while yielding a finite value at zero distance. In the disclosed core invention, epsilon is not a tuneable parameter family, but instead is fixed. The node coordinates used in the kernel may be spatial coordinates, learned latent coordinates, or precomputed positional embeddings. However, the source of the coordinates does not alter the identity of the kernel rule.

In practical implementations, the deterministic graph scale may be constrained to remain positive before normalization is performed. For example, if an edge set is empty, degenerate, or produces a zero or near-zero graph scale, the implementation may use a predetermined positive floor, a small positive offset, a self-loop-aware edge set, or another deterministic positive conditioning rule. Such conditioning preserves numerical well-definedness of the ratio and denominator operations while maintaining the disclosed scale-normalized inverse-square kernel in which edge weights are computed from pairwise node-coordinate distance, deterministic graph scale, fixed damping epsilon=X_opt=phi/pi, and fixed inverse-square distance dependence.

A central property of the disclosed kernel is that the edge weights are exactly invariant under uniform graph dilation. As illustrated in FIG. 2, if node coordinates undergo the transformation x->λx for lambda>0, then pairwise coordinate distances scale as:

∥lambda x_i−lambda x_j∥\hat{ }2=lambda\hat{ }2∥x_i−x_j∥\hat{ }2

and the deterministic graph scale scales proportionally as:

s_G(lambda x)=lambda s_G(x)

Substituting those relations into the disclosed kernel yields:

w_ij(lambda x)=(lambda\hat{ }2 s_G\hat{ }2)/(lambda\hat{ }2∥x_i−x_j∥\hat{ }2+(epsilon lambda s_G)\hat{ }2)=w_ij(x)

Accordingly, the disclosed edge weights are exactly invariant under uniform graph dilation. This is not an approximate normalization effect and not a heuristic scale correction. Rather, it is an exact consequence of the deterministic scaling of s_G together with the disclosed normalized inverse-square form of the kernel.

Because the computed edge weights are used during graph neural-network message passing, the disclosed kernel does not merely report a mathematical relationship. The computed weights alter the numerical messages aggregated at graph nodes, thereby changing updated node representations generated by the graph neural network. Those updated representations may then be supplied to a downstream task head for classification, regression, prediction, or another machine-learning task. The disclosed operation therefore provides a processor-implemented improvement to graph neural-network processing by producing scale-invariant message passing under uniform graph dilation.

The disclosed invention fixes the exponent at −2. The exponent is not introduced as one arbitrary member of a family of interchangeable power laws. In the disclosed theoretical framing, the exponent −2 corresponds to the inverse-square energy-density form associated with the relevant harmonic construction. The disclosure ties the exponent −2 to the Recognition-Science stationary-action kernel and states that use of a different exponent breaks the stated stationarity condition and the closed-form guarantees relied on by the disclosure. The disclosed rule set is therefore not an interchangeable power-law family; the fixed exponent −2 forms part of the defined kernel rule rather than merely illustrating one selectable value among many alternatives.

The disclosure further presents ablation evidence showing that nearby exponents underperform the disclosed exponent, with the optimum reported at exactly −2. Such ablation evidence supports the disclosed fixed exponent but does not define it.

The disclosed kernel is distinguished from conventional graph neural-network kernels not merely by using a distance-dependent weight, but by the combined rule requiring deterministic graph-scale normalization, a fixed inverse-square exponent, a fixed damping value epsilon=X_opt=phi/pi, and exact invariance of the resulting edge weights under uniform graph dilation. Degree-normalized, attention-based, Gaussian, Bessel, learned edge-function, and uniform aggregation approaches do not provide this same combination of deterministic scale normalization, fixed damping, fixed exponent, and dilation-invariant edge weights.

The disclosed kernel has the following mathematical properties. First, the kernel is positive: w_ij>0 for all i, j. Second, the kernel is symmetric: w_ij=w_ji. Third, the kernel is bounded above due to the fixed damping term: w_ij<=1/epsilon\hat{ }2. Fourth, the kernel is localized in that the weight tends to zero as distance tends to infinity: w_ij->0 as ∥x_i−x_j∥->infinity. Fifth, the kernel yields a finite self-loop weight: w_ii=1/epsilon\hat{ }2=(pi/phi)\hat{ }2≈3.769853425701. These properties follow directly from the disclosed kernel form and from the use of the fixed regularizing constant epsilon=X_opt=phi/pi. They are properties of the kernel itself and do not depend on any particular downstream application, benchmark result, software framework, or hardware realization.

The disclosed kernel is used in graph neural-network message passing by weighting transformed neighbor features with the disclosed edge weights. As shown in FIGS. 1, 3, and 4, a preferred message-passing implementation computes messages according to:

m_ij=w_ij×(W h_j)

and updates node representations according to:

h_inew=sigma(sum over j in N(i) of m_ij)

where W is a learnable transformation applied to node features and sigma is an activation function. In one example method flow, graph data may be received at block 300, node features may be received at block 302, node coordinates may be received at block 304, an edge set may be determined at block 306, a deterministic graph scale may be computed at block 308, edge weights may be computed at block 310, source-node features may be transformed at block 312, weighted messages may be generated at block 314, messages may be aggregated at block 316, an activation or update may be applied at block 318, and updated node or graph outputs may be produced at block 320.

The node coordinates used in the disclosed kernel may be spatial coordinates, learned latent coordinates, or precomputed positional embeddings. As shown in FIG. 5, a coordinate-source embodiment diagram 500 may include a spatial-coordinate source 502, latent-coordinate generator 504, precomputed embedding source 506, coordinate-selection module 508, native edge-set path 510, k-nearest-neighbor edge-construction path 512, sparse graph-processing path 514, and message-passing graph output 516. In some implementations, the graph edges used for message passing may correspond to a native graph edge set; in other implementations, the edge set may be constructed according to a k-nearest-neighbor rule or other sparse neighbor-selection process while preserving use of the same disclosed kernel on the selected edges.

The disclosure includes software embodiments in PyTorch Geometric and DGL implementing the disclosed kernel as a graph message-passing layer. These implementations provide concrete make-and-use support for deterministic graph-scale computation, normalized inverse-square edge-weight computation, weighted message generation, and aggregation to produce updated node features. The disclosure includes a concrete PyTorch Geometric implementation of a message-passing layer using the disclosed kernel. In one example implementation:
import torch, math from torch_geometric.nn import MessagePassing
PHI=(1+5**0.5)/2XOPT=PHI/math.piclass R2Conv(MessagePassing): def __init__(self, in_dim, out_dim): super( ).__init__(aggr=‘add’) self.W=torch.nn.Linear(in_dim, out_dim, bias=False)def forward(self, x, pos, edge_index): row, col=edge_index diff=pos[row]−pos[col] s=(diff.pow(2).sum(dim=−1).mean( )+1e−12).sqrt( ) pos=pos/s return self.propagate(edge_index, x=self.W(x), pos=pos)def message(self, x_j, pos_i, pos_j): diff=pos_i−pos_j dist_sq=(diff**2).sum(dim=−1, keepdim=True)+XOPT**2 return x_j/dist_sq

In this implementation, graph connectivity is used to obtain source and destination indices for edges, coordinate differences are computed across those edges, a deterministic graph scale is computed from those differences, node positions are normalized by the graph scale, and inverse-square edge weights are applied to transformed source features in order to generate messages that are aggregated at destination nodes. This implementation is illustrative only and does not limit the disclosed kernel rule to any particular software framework. In another illustrative implementation, the disclosed kernel is implemented in DGL. A DGL realization may similarly compute coordinate differences, compute a deterministic graph scale, normalize coordinates, compute inverse-square edge weights, and aggregate weighted messages to produce updated node features. The existence of both PyTorch Geometric and DGL implementations demonstrates that the disclosed kernel may be realized across multiple software ecosystems while preserving the same mathematical rule. As shown in FIG. 4, a preferred message-passing layer architecture 400 may include layer input features 402, layer input coordinates 404, edge-index input 406, feature-transform module 408, graph-scale computation module 410, normalized-distance module 412, inverse-square weight module 414, message-formation module 416, aggregation module 418, and output feature module 420.

As depicted in FIG. 6, the disclosure includes formal verification support for selected mathematical properties of the disclosed kernel. In one formalization, the disclosed proof support includes theorem statements corresponding to kernel_positive—w_ij>0; kernel_scale_invariant—w_ij(λx)=w_ij(x) via s_G normalization; damping_from_phi—epsilon=phi/pi; damping_positive—epsilon>0; exponent_fixed—exponent=−2; and parameter_free_count or parameter_free—no learned edge-kernel hyperparameters. These formal results support the internal mathematical coherence of the disclosed kernel rule. The formal-verification discussion is limited to mathematical and structural properties of the disclosed kernel. Empirical benchmark outcomes, convergence behavior, and runtime overhead are not treated here as theorem-proved properties and are addressed separately in the experimental validation section.

The disclosure includes experimental benchmark results and ablation data supporting implementation of the disclosed kernel in selected graph-learning settings. These results are presented as validation of implemented embodiments and not as part of the definition of the kernel itself. An example benchmark embodiment uses QM9 molecular property prediction. In one reported comparison: Model/Kernel/MAE (meV)/Epochs—GIN/uniform/78.3/300; SchNet/Gaussian/64.2/300; DimeNet/Bessel/52.1/300; and R2Conv/s_G-normalized r\hat{ }-2/47.5/180. An example benchmark embodiment uses OGB-ArXiv node classification. In one reported comparison: Model/Kernel/Accuracy/Epochs—GCN/degree-normalized/71.7%/500; GAT/attention/72.1%/400; and R2Conv/s_G-normalized r\hat{ }-2/72.8%/250. An example benchmark embodiment uses protein-protein interaction graphs. In one reported comparison: Model/Micro-F1/Epochs—GraphSAGE/61.2%/500; GAT/97.3%/400; and R2Conv/97.9%/240. The disclosure further includes ablation data evaluating nearby exponents around the disclosed inverse-square exponent. In one reported comparison: Exponent/Accuracy (OGB)/MAE (QM9, meV)—−1.5/71.0%/56.2; −1.8/71.6%/50.1; −2.0/72.8%/47.5; −2.2/72.0%/49.3; and −2.5/71.3%/53.8. The reported optimum occurs at exactly −2, consistent with the disclosed fixed exponent. The disclosed kernel has been described in connection with implemented embodiments including molecular graphs, citation networks, and protein interaction graphs. In some implementations, validation may additionally include molecular prediction error relative to selected baselines, citation-network classification accuracy relative to selected baselines, protein interaction performance relative to selected baselines, exponent sweeps in a range surrounding −2, and runtime-overhead measurement relative to a selected baseline. Such validation pathways are exemplary only and do not define the kernel rule.

Optional and alternative embodiments may include sparse application of the disclosed kernel to a restricted neighbor set, directional modulation of the disclosed kernel, multi-head embodiments, temporal extensions, and hyperbolic-distance embodiments. In an optional multi-head embodiment, multiple inverse-square heads may operate at phi-spaced scales derived from X_opt so that each head preserves the same inverse-square form while resolving interactions at distinct scale levels. In an optional temporal embodiment for spatiotemporal graphs, the denominator may include a temporal-separation term so that interaction weight depends on spatial separation and temporal separation while retaining an inverse-square-centered scale-normalized structure.

In an optional hyperbolic embodiment for hierarchical graphs, Euclidean pairwise distance may be replaced by hyperbolic distance while preserving deterministic graph-scale normalization and the disclosed inverse-square-centered weighting logic. As illustrated in FIG. 7, an optional/alternative kernel diagram 700 may include a base-kernel embodiment 702, directional branch 704, multi-head branch 706, temporal branch 708, hyperbolic branch 710, and sparse-neighbor branch 712.

In an optional system embodiment, the disclosed kernel may be implemented using specialized arithmetic logic or accelerator circuitry configured to compute the scale-normalized inverse-square function used in the disclosed message-passing kernel. A dedicated inverse-square arithmetic unit may, in some implementations, receive a distance-related input and a graph-scale-related input and output a normalized inverse-square quantity corresponding to the disclosed kernel rule. Reciprocal or inverse-square evaluation may be implemented using approximation circuitry including, by way of example only, Newton-Raphson-based reciprocal logic or other fixed-function arithmetic structures, without altering the identity of the disclosed kernel. As shown in FIG. 8, an example processor-implemented system 800 may include a processor 802, memory 804, graph data store 806, feature-transform engine 808, graph-scale computation engine 810, inverse-square kernel engine 812, aggregation engine 814, optional dedicated arithmetic accelerator 816, and output interface 818.

The following application examples illustrate contexts in which the disclosed kernel may be used. As depicted in FIG. 9, illustrative contexts may include molecular-graph application 900, materials-graph application 902, citation-network application 904, protein-interaction application 906, autonomous-scene-graph application 908, social-network application 910, point-cloud application 912, and multi-resolution transfer application 914. In some implementations, the disclosed scale-invariant kernel may facilitate deployment across graphs of differing resolution or scale without requiring alteration of the core kernel rule; such use remains subordinate to the invention's defined kernel structure and does not redefine the invention.

The disclosed kernel may be interoperable with other Recognition-Science-derived modules in broader machine-learning systems. References to other Recognition-Science patents or modules are provided, if at all, only as broader context and not as part of the definition of the present invention.

What is claimed is:

1. A computer-implemented method of updating node features in a graph neural network, the method comprising: receiving graph connectivity for a graph comprising a plurality of nodes and a plurality of edges; receiving coordinates associated with at least some of the plurality of nodes;
computing a deterministic graph scale from graph geometry; computing, for at least some of the plurality of edges, an edge weight according to w_ij=s_G\hat{ }2/(∥x_i−x_j∥\hat{ }2+(epsilon s_G)\hat{ }2),
where s_G is the deterministic graph scale, epsilon is fixed at X_opt=phi/pi, and an exponent on distance is fixed at −2; generating weighted messages based on the computed edge weights; and
aggregating the weighted messages to produce updated node features, wherein the computed edge weights are invariant under uniform graph dilation by virtue of deterministic scaling of the deterministic graph scale.

2. The method of claim 1, wherein the edge weights satisfy w_ij(lambda x)=w_ij(x) for uniform graph dilation x->lambda x.

3. The method of claim 1, wherein the deterministic graph scale is computed according to s_G\hat{ }2=(1/|E|) sum over (i,j) in E of ∥x_i−x_j∥\hat{ }2, where E is an edge set used for message passing.

4. The method of claim 1, wherein the edge weight is equivalently computed according to w_ij=1/(((∥x_i−x_j∥)/s_G)\hat{ }2+epsilon\hat{ }2).

5. The method of claim 1, wherein the method uses no learned attention weights and no learned edge-weight hyperparameters.

6. The method of claim 1, wherein generating weighted messages comprises computing messages according to m_ij=w_ij×(W h_j), where W is a learnable transformation applied to node features.

7. The method of claim 6, wherein aggregating the weighted messages comprises computing updated node features according to h_i\hat{ }new=sigma(sum over j in N(i) of m_ij), where sigma is an activation function.

8. The method of claim 1, wherein the coordinates comprise spatial coordinates, learned latent coordinates, or precomputed positional embeddings.

9. The method of claim 1, wherein the graph connectivity comprises a native graph edge set or a k-nearest-neighbor edge set.

10. The method of claim 1, wherein the deterministic graph scale is computed on a per-graph basis or on a per-batch basis, and wherein the edge weights are computed for all edges or for a sparse subset of edges.

11. A graph neural-network message-passing layer comprising: a graph-scale computation module configured to compute a deterministic graph scale from graph geometry; an inverse-square kernel module configured to compute, for at least some graph edges, edge weights according to w_ij=s_G\hat{ }2/(r\hat{ }2+(epsilon s_G)\hat{ }2), where epsilon is fixed at X_opt=phi/pi and an exponent on distance is fixed at −2; a message-generation module configured to generate weighted messages using the computed edge weights; and an aggregation module configured to output updated node features, wherein the computed edge weights are invariant under uniform graph dilation by virtue of deterministic scaling of the deterministic graph scale.

12. The layer of claim 11, wherein the layer uses no learned attention weights and no learned edge-weight hyperparameters.

13. The layer of claim 11, wherein the message-generation module is configured to compute messages according to m_ij=w_ij×(W h_j), and the aggregation module is configured to compute updated node features according to h_i\hat{ }new=sigma(sum over j in N(i) of m_ij).

14. The layer of claim 11, wherein the layer is configured as a drop-in replacement for a graph convolution or graph attention message-passing layer in a graph neural-network framework.

15. A graph neural-network processing system comprising:
memory storing graph connectivity, node features, and node coordinates;
one or more processors configured to compute a deterministic graph scale from graph geometry;
a kernel engine configured to compute scale-normalized inverse-square edge weights using pairwise node-coordinate distance and a damping term coupled to the deterministic graph scale,
wherein the damping term corresponds to epsilon fixed at X_opt=phi/pi and an exponent on distance is fixed at −2;
a message-generation engine configured to generate weighted messages based on the computed edge weights; and
an aggregation engine configured to output updated node features,
wherein the edge weights are invariant under uniform graph dilation by virtue of deterministic scaling of the deterministic graph scale.

16. The system of claim 15, further comprising specialized arithmetic logic configured to accelerate computation of the scale-normalized inverse-square edge weights.

17. A non-transitory computer-readable medium storing instructions that, when executed by one or more processors, cause the one or more processors to:
receive graph connectivity for a graph comprising a plurality of nodes and a plurality of edges;
receive coordinates associated with at least some of the plurality of nodes;
compute a deterministic graph scale from graph geometry;
compute, for at least some of the plurality of edges, an edge weight according to a scale-normalized inverse-square function of pairwise node-coordinate distance and a damping term coupled to the deterministic graph scale, wherein the damping term corresponds to epsilon fixed at X_opt=phi/pi and an exponent on distance is fixed at −2;
generate weighted messages based on the computed edge weights; and
aggregate the weighted messages to produce updated node features,
wherein the computed edge weights are invariant under uniform graph dilation by virtue of deterministic scaling of the deterministic graph scale.

18. The non-transitory computer-readable medium of claim 17, wherein the instructions cause the one or more processors to compute the deterministic graph scale according to s_G\hat{ }2=(1/|E|) sum over (i,j) in E of ||x_i−x_j∥\hat{ }2.

19. The non-transitory computer-readable medium of claim 17, wherein the instructions cause the one or more processors to compute messages according to m_ij=w_ij×(W h_j) and updated node features according to h_i\hat{ }new=sigma(sum over j in N(i) of m_ij).

20. The non-transitory computer-readable medium of claim 17, wherein the instructions are embodied in a software module configured for a graph neural-network framework that performs message passing using the computed edge weights.
